(19) United States
(12) Patent Application Publication
(10) Pub. No.: US 2007/0094248 A1
(43) Pub. Date: Apr. 26, 2007

(54) System and method for managing content by workflows

(75) Inventors: Ryan Sean McVeigh, Broomfield, CO (US); Steven L. Roth, Westminster, CO (US); Jalpesh Patadia, Boulder, CO (US); Tanya Saarva, Boulder, CO (US); Xiaojiang Zhou, Broomfield, CO (US); Brad Posner, Erie, CO (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/473,572

(22) Filed: Jun. 23, 2006

Related U.S. Application Data
(60) Provisional application No. 60/720,860, filed on Sep. 26, 2005.

(51) Int. Cl. G06F 17/30

(52) U.S. Cl. 707/4

(57) ABSTRACT

In accordance with embodiments, there are provided mechanisms and methods for managing content by workflows. These mechanisms and methods for managing content by workflows can, in embodiments, enable users to define workflows for managing content, including defining one or more of a state in the workflow, a transition from a first state to a second state and an action to be associated with a state. Some embodiments can also provide the ability to select an applicable workflow from a set of workflows in order to provide actions for managing content.

### CLAIM OF PRIORITY

This application claims the benefit of U.S. Provisional Patent Application No. 60/720,860 entitled IMPROVED CONTENT MANAGEMENT, by Ryan McVeigh et al., filed Sep. 26, 2005 (Attorney Docket No. BEAS-01968US0), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. patent application No.______, entitled SYSTEM AND METHOD FOR PROVIDING DISPLAY TEMPLATES FOR CONTENT MANAGEMENT, by Ryan McVeigh al., filed on May ______, 2006, Attorney Docket No. BEAS-1882US0; and

U.S. patent application No. ______, entitled SYSTEM AND METHOD FOR MANAGING CONTENT BY WORKFLOWS, by Ryan McVeigh al., filed on May ______, 2006, Attorney Docket No. BEAS-1889US0.

### FIELD OF THE INVENTION

The current invention relates generally to managing content for use with portals and other content delivery mechanisms, and more particularly to a mechanism for managing content by workflows.

### BACKGROUND

Content repositories manage and provide access to large data stores such as a newspaper archives, advertisements, inventories, image collections, etc. A content repository can be a key component of a web application such as a portal, which must quickly serve up different types of content in response to user interaction. However, difficulties can arise when trying to integrate more than one vendor's content repository. Each may have its own proprietary application program interface and content services (e.g., conventions for searching and manipulating content, versioning, workflows, and data formats). Furthermore, each time a repository is added to an application, the application software must be modified to accommodate these differences. What is needed is a coherent system and method for interacting with disparate repositories and for providing a uniform set of content services across all repositories, including those that lack such services.

### BRIEF DESCRIPTION OF THE DRAWINGS

FIG. 1 is an illustration of an example of functional system layers in various embodiments.

FIG. 2 is an illustration of an example workflow in an embodiment.

FIG. 3 is an illustration of an example external scenario that invokes a workflow in various embodiments.

FIGS. 4A-4B are operational flow diagrams illustrating a high level overview of a technique for managing content by workflows in an embodiment.

FIG. 5 is an illustration of an example of objects/interfaces that can be used to interface repositories comprising content in various embodiments.

FIG. 6 illustrates a sample document that uses the above schema in an embodiment.

FIG. 7 is a hardware block diagram of an example computer system, which may be used to embody one or more components in an embodiment.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with embodiments, there are provided mechanisms and methods for managing content by workflows. These mechanisms and methods for managing content by workflows can, in embodiments, enable users to define workflows for managing content, including defining one or more of a state in the workflow, a transition from a first state to a second state and an action to be associated with a state. Some embodiments can also provide the ability to select an applicable workflow from a set of workflows in order to provide actions for managing content.

Workflows are useful for defining the interactions between a variety of users, each of which may take different actions on a document at different times. Some typical types of users include: a content administrator, an individual who manages content types, content approval workflows, and the general content hierarchy, a content creator, an individual who uses the content management system to create and edit content items, a content approver, an individual who approves content submissions from content creators, a content consumer, an individual who is the primary viewer of content (i.e. the visitor to the portal), a developer, an individual who creates “display” and “edit” templates as well as designs the portal and a DBA, who is responsible for maintaining an organization's database instances such as modifying or adding schemas. Embodiments can provide one or more of the following features to coordinate the actions of these types of users:
An open workflow document so that users can define their own transition rules. Users can, using tools, create, manage, update and delete workflow documents.
Allow users to associate a workflow document at the node level.
Support inheritance of workflow documents to allow a child node to use the workflow specified at the parent level if it does not have a workflow associated with it
Enable administrators to associate workflow document on types. The workflow document on types will take precedence over workflow document on nodes.
Workflow document set on subtypes will take precedence over workflow documents set on parent types.

In an embodiment and by way of example, a method for managing content by workflows in a content management system is provided. The method embodiment includes determining that an action needs to be taken on a document stored as content in at least one of a plurality of content repositories integrated into a virtual content repository (VCR). A selected workflow to be applied is determined from a hierarchically arranged set of workflows that specify actions to be performed on a document stored as content. The workflow includes a plurality of states, each state including a set of actions, and a plurality of transitions indicating a change to a next state. An action to be performed on the document is returned. The action is determined from an applicable state in accordance with the selected workflow.

As used herein, the term inheritance is defined as when an object extends or inherits from a parent object, it gains the functionality as described by that parent object. The object is also capable of modifying that functionality to suit the object's specific needs. For workflows, the functionality that can be extended and/or modified is the parent's workflow definitions. As used herein, the term requestors may one or more of a users, proxies or automated entity that makes a request. The term Users may refer to human or computational entities. As used herein, the term application is intended to be broadly construed to include any data entry, update, query or program that processes data on behalf of a user.

As used herein, the term service is intended to be broadly construed to include any application, program or process resident on one or more computing devices capable of providing services to a requester or other recipient, including without limitation network based applications, web based server resident applications, web portals, search engines, photographic, audio or video information storage applications, e-Commerce applications, backup or other storage applications, sales/revenue planning, marketing, forecasting, accounting, inventory management applications and other business applications and other contemplated computer implemented services. A remote portlet is a portlet utilized by a page stored on a site remote to the portlet. The term result set is defined as any result provided by one or more services. Result sets may include multiple entries into a single document, file, communication or other data construct.

While the present invention is described with reference to an embodiment in which techniques for managing content by workflows are implemented in an application server in conformance with the J2EE Management Framework using executable programs written in the Java™ programming language, the present invention is not limited to the J2EE Management Framework nor the Java™ programming language. Embodiments may be practiced using other interconnectivity specifications or programming languages, i.e., JSP and the like without departing from the scope of the embodiments claimed. (Java™ is a trademark of Sun Microsystems, Inc.).

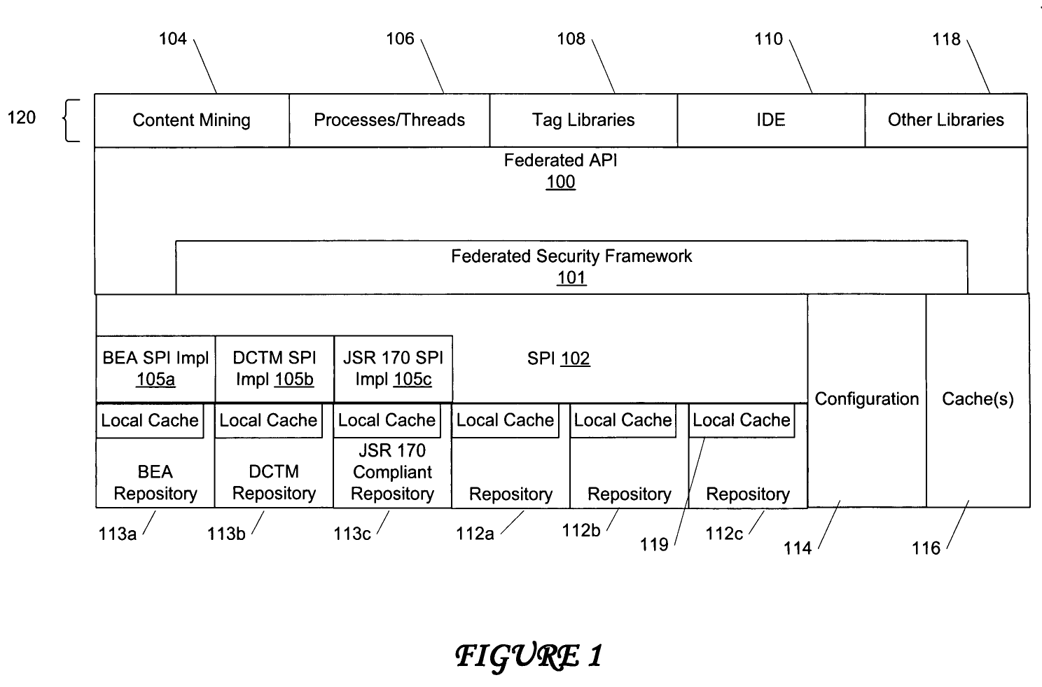

FIG. 1 is an illustration of an example of functional system layers in various embodiments of the invention. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

A content repository 112 represents a searchable data store. Such systems can relate structured content and unstructured content (e.g., digitally scanned paper documents, Extensible Markup Language, Portable Document Format, Hypertext Markup Language, electronic mail, images, video and audio streams, raw binary data, etc.) into a searchable corpus. Content repositories can be coupled to or integrated with content management systems. Content management systems can provide for content workflow management, versioning, content review and approval, automatic content classification, event-driven content processing, process tracking and content delivery to other systems. By way of illustration, if a user fills out a loan application on a web portal, the portal can forward the application to a content repository which, in turn, can contact a bank system, receive notification of loan approval, update the loan application in the repository and notify the user by rendering the approval information in a format appropriate for the web portal.

A virtual or federated content repository (hereinafter referred to as “VCR”) is a logical representation of one or more individual content repositories. For example, the VCR provides a single access point to multiple repositories from the standpoint of application layer 120 but does not shield from the user that there is more than one repository available. The VCR can also add content services to repositories that natively lack them. Typically, the user interacts with the VCR by specifying which repository an action is related to (such as adding a new node), or performing an action that applies to all repositories (such as searching for content). In various embodiments and by way of illustration, this can be accomplished in part by use of an API (application program interface) 100 and an SPI (service provider interface) 102. An API describes how entities in the application layer can interface with some program logic or functionality. The application layer can include applications (and subdivisions thereof) that utilize the API, such as processes, threads, servlets, portlets, objects, libraries, and other suitable application components. An SPI describes how a service provider (e.g., a content repository, a content management system) can be integrated into a system of some kind. The SPI isolates direct interaction with repositories from the API. In various embodiments, this can be accomplished at run-time wherein the API library dynamically links to or loads the SPI library. In another embodiment, the SPI can be part of a server process such that the API and the SPI can communicate over a network. The SPI can communicate with the repositories using any number of means including, but not limited to, shared memory, remote procedure calls and/or via one or more intermediate server processes.

Content repositories may comprise a variety of interfaces for connecting with the repository. For example, as shown in FIG. 1, a BEA format repository 113a provided by BEA Systems, Inc. of San Jose, Calif., a Documentum™ format repository 113b, provided by EMC Corp. of Hopkinton, Mass., and a JSR-170 compliant repository 113c may be integrated into a VCR and made accessible via a single federated API 100 by SPI 102. Individual SPI implementations 105a, 105b, 105c provide format specific service provider interfaces to the BEA format repository 113a, the Documentum™ format repository 113b, and the JSR-170 format repository 113c, respectively. It is noteworthy that not all of the formats illustrated in FIG. 1 will be present in all embodiments. Further, some embodiments will include other repository formats not illustrated by FIG. 1 for brevity.

API's and SPI's can be specified as a collection of classes/interfaces, data structures and/or methods/functions that work together to provide a programmatic means through which VCR service(s) can be accessed and utilized. By way of illustration, APIs and SPIs can be specified in an object-oriented programming language, such as Java™ (available from Sun Microsystems, Inc. of Mountain View, Calif.) and C# (available from Microsoft Corp. of Redmond, Wash.). The API and SPI can be exposed in a number of ways, including but not limited to static libraries, dynamic link libraries, distributed objects, servers, class/interface instances, and other suitable means.

In various embodiments, the API presents a unified view of all repositories to the application layer such that navigation, CRUD operations (create, read, update, delete), versioning, workflows, and searching operations initiated from the application layer operate on the repositories as though they were one. Repositories that implement the SPI can “plug into” the VCR. The SPI includes a set of interfaces and services that support API functionality at the repository level. The API and SPI share a content model that represents the combined content of all repositories as a hierarchical namespace of nodes. Given a node N, nodes that are hierarchically inferior to N are referred to as children of N, whereas nodes that are hierarchically superior to N are referred to as parents of N. The top-most level of the hierarchy is termed the federated root. There is no limit to the depth of the hierarchy. In various embodiments, repositories are children of the federated root. Each repository can itself have children.

By way of illustration, content mining facilities 104, processes/threads 106, tag libraries 108, integrated development environments (IDEs) 110, and other libraries 118 can all utilize the API to interact with a VCR. An IDE can provide the ability for a user to interactively build workflows and/or content views. Content mining facilities can include services for automatically extracting content from the VCR based on parameters. Java ServerPages™ tag libraries enable portals to interact with the VCR and surface its content on web pages. (Java ServerPages™ is available from Sun Microsystems, Inc.) In addition, it will be apparent to those of skill in the art that many other types of applications and software components utilize the API and are, as such, fully within the scope and spirit of the present disclosure.

In various embodiments, the API can include optimizations to improve the performance of interacting with the VCR. One or more caches 116 can be used to buffer search results and/or recently accessed nodes. Some implementations may include additional cache 119 in one or more repositories. In various embodiments, a cache can include a node cache and/or a binary cache. A node cache can be used to provide fast access to recently accessed nodes whereas a binary cache can be used to provide fast access to the binary content/data associated with each node in a node cache. The API can also provide a configuration facility 114 to enable applications, tools and libraries to configure caches and the VCR. In various embodiments, this facility can be can be configured via Java Management Extension (JMX) (available from Sun Microsystems, Inc.).

In various embodiments, a model for representing hierarchy information, content and data types is shared between the API and the SPI. In this model, a node can represent hierarchy information, content or schema information. Hierarchy nodes can serve as containers for other nodes in the namespace akin to a file subdirectory in a hierarchical file system. Schema nodes represent predefined data types. Content nodes represent content/data. Nodes can have a shape defined by their properties. A property associates a name, a data type and an optional a value that is appropriate for the type. In certain of these embodiments, the properties of content nodes contain values. By way of an illustration, a type can be any of the types described in Table 1. Those of skill in the art will appreciate that many more types are possible and fully within the scope and spirit of the present disclosure.

TABLE 1
Example Property Types in Various Embodiments

| PROPERTY | |
|---|---|
| TYPE | DESCRIPTION |
| Basic | Text, a number, a date/time, a Boolean value, a choice, an |
| | image, a sound, a bit mask, an audio/visual presentation, |
| | binary data. |
| Link | A pointer/reference to data that lives “outside” of a node. |
| Lookup | An expression to be evaluated for locating another node in |
| | the VCR |
| Database | Maps to an existing database table or view. |
| Mapped (or | |
| schema) | |
| Nested | One or more schemas define individual properties. |

In various embodiments, a property can also indicate whether it is required, whether it is read-only, whether it provides a default value, and whether it specifies a property choice. A property choice indicates if a property is a single unrestricted value, a single restricted value, a multiple unrestricted value, or a multiple restricted value. Properties that are single have only one value whereas properties that are multiple can have more than one value. If a property is restricted, its value(s) are chosen from a finite set of values. But if a property is unrestricted, any value(s) can be provided for it. A property can also be designated as a primary property. By way of illustration, the primary property of a node can be considered its default content. For example, if a node contained a binary property to hold an image, it could also contain a second binary property to represent a thumbnail view of the image. If the thumbnail view was the primary property, software applications such as browser could display it by default.

A named collection of one or more property types is a schema. A schema node is a place holder for a schema. In various embodiments, schemas can be used to specify a node's properties. By way of illustration, a Person schema with three properties (Name, Address and DateofBirth) can be described for purposes of discussion as follows:

```
Schema Person = {
    <Name=Name, Type=Text>,
    <Name=Address, Type=Address>,
    <Name=DateofBirth, Type=Date>}
```

Various embodiments allow a node to be defined based on a schema. By way of illustration, a content node John can be given the same properties as the schema Person:
Content Node John is a Person

In this case, the node John would have the following properties: Name, Address and DateofBirth. Alternatively, a node can use one or more schemas to define individual properties. This is sometimes referred to as nested types. In the following illustration, John is defined having an Info property that itself contains the properties Name, Address and DateofBirth. In addition, John also has a CustomerId property:

```
Content Node John = {
    <Name=Info, Type=Person>,
    <Name=CustomerId, Type=Number> }
```

Schemas can be defined logically in the VCR and/or in the individual repositories that form the VCR. In certain embodiments, schemas can inherit properties from at least one other schema. Schema inheritance can be unlimited in depth. That is, schema A can inherit from schema B, which itself can inherit from schema C, and so on. If several schemas contain repetitive properties, a “base” schema can be configured from which the other schemas can inherit. For example, a Person schema containing the properties Name, Address and DateofBirth, can be inherited by an Employee schema which adds its own properties (i.e., Employee ID, Date of Hire and Salary):

```
Schema Employee inherits from Person = {
    <Name=EmployeeID, Type= Number>,
    <Name=DateofHire, Type=Date>,
    <Name=Salary, Type= Number> }
```

Thus, as defined above the Employee schema has the following properties: Name, Address, DateofBirth, EmployeeID, DateofHire and Salary. If the Person schema had itself inherited properties from another schema, those properties would also belong to Employee.

In various embodiments, nodes have names/identifiers and can be specified programmatically or addressed using a path that designates the node's location in a VCR namespace. By way of illustration, the path can specify a path from the federated root (‘/’) to the node in question (‘c’):
/a/b/c

In this example, the opening ‘/’ represents the federated root, ‘a’ represents a repository beneath the federated root, ‘b’ is a hierarchy node within the ‘a’ repository, and ‘c’ is the node in question. The path can also identify a property (“propertyl ”) on a node:
/a/b/c.property1

In aspects of these embodiments, the path components occurring prior to the node name can be omitted if the system can deduce the location of the node based on context information.

In various embodiments, a schema defined in one repository or the VCR can inherit from one or more schemas defined in the same repository, a different repository or the VCR. In certain aspects of these embodiments, if one or more of the repositories implicated by an inherited schema do not support inheritance, the inheriting schema can be automatically defined in the VCR by the API. In one embodiment, the inheriting schema is defined in the VCR by default.

By way of illustration, the Employee schema located in the Avitech repository inherits from the Person schema located beneath the Schemas hierarchy node in the BEA repository:

```
Schema /Avitech/Employee inherits from /BEA/Schemas/Person = {
    <Name=EmployeeID, Type= Number>,
    <Name=DateofHire, Type=Date>,
    <Name=Salary, Type= Number> }
```

In various embodiments, the link property type (see Table 1) allows for content reuse and the inclusion of content that may not be under control of the VCR. By way of illustration, the value associated with a link property can refer/point to any of the following: a content node in a VCR, an individual property on a content node in a VCR, a file on a file system, an object identified by a URL (Uniform Resource Locator), or any other suitable identifier. In various embodiments, when editing a content node that has a link property type, a user can specify the link destination (e.g., using a browser-type user interface). In certain aspects of these embodiments, if a link refers to a content node or a content node property that has been moved, the link can be resolved automatically by the system to reflect the new location.

In various embodiments, a value whose type is lookup (see Table 1) can hold an expression that can be evaluated to search the VCR for instances of content node(s) that satisfy the expression. Nodes that satisfy the expression (if any) can be made available for subsequent processing. In various embodiments, a lookup expression can contain one or more expressions that can substitute expression variables from: the content node containing the lookup property, a user profile, anything in the scope of a request or a session. In various embodiments, an expression can include mathematical, logical and Boolean operators, function/method invocations, macros, SQL (Structured Query Language), and any other suitable query language. In various embodiments, an expression can be pre-processed one or more times to perform variable substitution, constant folding and/or macro expansion. It will be apparent to those of skill in the art that many other types of expressions are possible and fully within the scope and spirit of this disclosure.

In various embodiments, when editing a content node that has a lookup property type, the user can edit the expression through a user interface that allows the user to build the expression by either entering it directly and/or by selecting its constituent parts. In addition, the user interface can enable the user to preview the results of the expression evaluation.

Database mapped property types (see Table 1) allow information to be culled (i.e., mapped) from one or more database tables (or other database objects) and manipulated through node properties. By way of illustration, a company might have “content” such as news articles stored as rows in one or more RDBMS (Relational Database Management System) tables. The company might wish to make use of this “content” via their portal implementation. Further, they might wish to manage the information in this table as if it existed in the VCR. Once instantiated, a content node property that is of the database mapped type behaves as though its content is in the VCR (rather than the database table). In one embodiment, all API operations on the property behave the same but ultimately operate on the information in the database table.

In various embodiments, a given database mapped property type can have an expression (e.g., SQL) which, when evaluated, resolves to a row and a column in a database table (or resolves to any kind of database object) accessible by the system over one or more networks. A database mapped property will be able to use either native database tables/objects or database views on those tables/objects. It will be appreciated by those of skill in the art that the present disclosure is not limited to any particular type of database or resolving expression.

In aspects of certain embodiments, a schema can be automatically created that maps to any row in a database table. The system can inspect the data structure of the table and pre-populate the schema with database mapped properties corresponding to columns from the table. The table column names can be used as the default property names and likewise the data type of each column will determine the data type of each corresponding property. The system can also indicate in the schema which properties correspond to primary key columns. If certain columns from the table are not to be used in the new schema, they can be un-mapped (i.e. deselected) by a user or a process. A content node can be based on such a schema and can be automatically bound to a row in a database table (or other database object) when it is instantiated. In various embodiments, a user can interactively specify the database object by browsing the database table.

While not required by all embodiments, some embodiments employ a display template (or “template”) to display content based on a schema. Templates can implement various “views”. By way of illustration, views could be “full”, “thumbnail”, and “list” but additional “views” could be defined by end-users. A full view can be the largest, or full page view of the content. A thumbnail view would be a very small view and a list view can be used when displaying multiple content nodes as a “list” on the page (e.g., a product catalog search results page). In various embodiments, the association between a schema and templates can be one-to-many. A template can be designated as the default template for a schema. In certain of these embodiments, templates can be designed with the aid of an integrated development environment (IDE). It is noteworthy that template technology is not limited to web applications. Other delivery mechanisms such as without limitation mobile phones, XML, and the like can be enabled by this technology.

In various embodiments and by way of illustration, display templates can be implemented using HTML (Hypertext Markup Language) and JSP (Java® Server Pages). By way of a further illustration, such a display template can be accessed from a web page through a JSP tag that can accept as an argument the identifier of a content node. Given the content node, the node's schema and associated default display template can be derived and rendered. Alternatively, the JSP tag can take an additional argument to specify a view other than the default. In another embodiment, display templates can be automatically generated (e.g., beforehand or dynamically at run-time) based on a content node's schema. In other embodiments, the view (e.g., full, thumbnail, list) can be determined automatically based on the contents of an HTTP request.

In various embodiments, a role is a dynamic set of users. By way of illustration, a role can be based on functional responsibilities shared by its members. In aspects of these embodiments, a role can be defined by one or more membership criteria. Role mapping is the process by which it is determined whether or not a user satisfies the membership criteria for a given role. For purposes of discussion, a role can be described as follows:
Role=PMembers+[Membership Criteria]

where PMembers is a set of user(s), group(s) and/or other role(s) that form a pool of potential members of this role subject to the Membership Criteria, if any. A user or a process can be in a role, if that user or process belongs to PMembers or satisfies the Membership Criteria. It is noteworthy that a user or process does not need to be a member of PMembers to be considered a member of the role. For example, it is possible to define a role with a criterion such as: “Only on Thursdays” as its membership criteria. All users would qualify as a member of this role on Thursdays. The Membership Criteria can include one or more conditions. By way of illustration, such conditions can include, but are not limited to, one or more (possibly nested and intermixed) Boolean, mathematical, functional, relational, and/or logical expressions. By way of illustration, consider the following Administrator role:
Administrator=Joe, Mary, SuperUser+CurrentTime>5:00 pm

The role has as its potential members two users (Joe and Mary) and users belonging to the user group named SuperUser. The membership criteria includes a condition that requires the current time to be after 5:00 pm. Thus, if a user is Joe, Marry or belongs to the SuperUser group, and the current time is after 5:00 pm, the user is a member of the Administrator role.

In various embodiments, roles can be associated with Resource(s). By way of illustration, a resource can be any system and/or application asset (e.g., VCR nodes and node properties, VCR schemas and schema properties, operating system resources, virtual machine resources, J2EE application resources, and any other entity that can be used by or be a part of software/firmware of some kind). Typically, resources can be arranged in one or more hierarchies such that parent/child relationships are established (e.g., the VCR hierarchical namespace and the schema inheritance hierarchy). In certain of these embodiments, a containment model for roles is followed that enables child resources to inherit roles associated with their parents. In addition, child resources can override their parents' roles with roles of their own.

In various embodiments, Membership Criteria can be based at least partially on a node's properties. This allows for roles that can compare information about a user/process to content in the VCR, for example. In various embodiments, a node's property can be programmatically accessed using dot notation: Article.Creator is the Creator property of the Article node. By way of illustration, assume an Article node that represents a news article and includes two properties: Creator and State. A system can automatically set the Creator property to the name of the user that created the article. The State property indicates the current status of the article from a publication workflow standpoint (e.g., whether the article is a draft or has been approved for publication). In this example, two roles are defined (see Table 2).

TABLE 2
Example Roles in an Embodiment

| ROLE | ASSOCIATED | | MEMBERSHIP |
|---|---|---|---|
| NAME | WITH | PMEMBERS | CRITERIA |
| Submitter | Article | Article.Creator | Article.State = Draft |
| Approver | Article | Editor | Article.State = (Submitted |
| | | | or |
| | | | Approved) |

The Submitter and Approver roles are associated with the Article node. Content nodes instantiated from this schema will inherit these roles. If a user attempting to access the article is the article's creator and the article's state is Draft, the user can be in the Submitter role. Likewise, if a user belongs to an Editor group and the article's state is Submitted or Approved, then the user can belong to the Approver role.

In various embodiments, a policy can be used to determine what capabilities or privileges for a given resource are made available to the policy's Subjects (e.g., user(s), group(s) and/or role(s)). For purposes of discussion, a policy can be described as follows:

Policy = Resource + Privilege(s) + Subjects +
[Policy Criteria]

Policy mapping is the process by which Policy Criteria, if any, are evaluated to determine which Subjects are granted access to one or more Privileges on a Resource. Policy Criteria can include one or more conditions. By way of illustration, such conditions can include, but are not limited to, one or more (possibly nested and intermixed) Boolean, mathematical, functional, relational, and/or logical expressions. Aspects of certain embodiments allow policy mapping to occur just prior to when an access decision is rendered for a resource.

Similar to roles, in certain of these embodiments a containment model for policies is followed that enables child resources to inherit policies associated with their parents. In addition, child resources can override their parents' polices with policies of their own.

In various embodiments, policies on nodes can control access to privileges associated with the nodes. By way of illustration, given the following policies:

Policy1 = Printer504 + Read/View + Marketing
Policy2 = Printer504 + All + Engineering

the Marketing role can read/view the Printer504 resource whereas the Engineering role has full access to it (“All”). These privileges are summarized in Table 3. Policy1 allows a user in the Marketing role to merely view the properties of Printer504 whereas Policy2 allows a user in the Engineering role to view and modify its properties, to create content nodes based on Printer504 (assuming it is a schema), and to delete the resource.

TABLE 3
Example Privileges for a “Printer504” Node in Various Embodiments

| ROLE | CREATE | READ/VIEW | UPDATE | DELETE |
|---|---|---|---|---|
| Marketing | | X | | |
| Engineering | x | X | x | X |

Aspects of certain of these embodiments include an implied hierarchy for privileges wherein child privilege(s) of a parent privilege are automatically granted if the parent privilege is granted by a policy.

In various embodiments, the containment models for polices and roles are extended to allow the properties of a node to inherit the policies and roles that are incident on the node. Roles/polices on properties can also override inherited roles/polices. For purposes of illustration, assume the following policy on a Power property of Printer504:
Policy3=Printer504. Power+Update+Marketing

In Policy3, the Marketing role is granted the right to update the Power property for the printer resource Printer504 (e.g., control whether the printer is turned on or off). By default, the Read/View property is also granted according to an implied privilege hierarchy. (There is no Browse privilege for this property.) See Table 4. Alternatively, if there was no implied privilege hierarchy, the Power property would inherit the read/view privilege for the Marketing role from its parent, Printer5O4. Although no policy was specified for the Power property and the Engineering role, the privileges accorded to the Engineering role can be inherited from a parent node. These privileges are summarized in Table 4.

TABLE 4
Example Privileges for the “Power” Property in the “Printer504” Node

| ROLE | CREATE | READ/VIEW | UPDATE | DELETE |
|---|---|---|---|---|
| Marketing | | X | x | |
| Engineering | X | X | x | x |

In various embodiments, the ability to instantiate a node based on a schema can be privileged. This can be used to control which types of content can be created by a user or a process. By way of illustration, assume the following policy:
Policy4=Press_Release+Instantiate+Marketing, Manager

Policy4 specifies that nodes created based on the schema Press_Release can only be instantiated by users/processes who are members of the Marketing and/or Manager roles. In aspects of certain of these embodiments, user interfaces can use knowledge of these policies to restrict available user choices (e.g., users should only be able to see and choose schemas on which they have the Instantiate privilege).

In various embodiments, policies can be placed on schemas. For purposes of illustration, assume the following policies:

Policy5 = Press_Release + Read/View + Everyone
Policy6 = Press_Release + All + Public_Relations

TABLE 5
Example Privileges for the “Press Release” Schema

| | CREATE | READ/ | | | |
|---|---|---|---|---|---|
| ROLE | INSTANCE | VIEW | UPDATE | DELETE | BROWSE |
| Everyone | | X | | | x |
| Public | x | X | x | x | x |
| Relations | | | | | |

With reference to Table 5 and by way of illustration, assume a content node instance was created based on the Press Release schema. By default, it would have the same roles/polices as the Press Release schema. If a policy was added to the node giving a role “Editor” the privilege to update the node, the result would be additive. That is, “Everyone” and “Public Relations” would maintain their original privileges.

In various embodiments, policies can be placed on properties within a schema, including property choices. (Property choices are a predetermined set of allowable values for a given property. For example, a “colors” property could have the property choices “red”, “green” and “blue”.)

In various embodiments, content and schema nodes can follow workflows. In certain aspects of these embodiments, a workflow can set forth: a set of states through which a node can pass; actions that can occur as part of or resulting from state transitions; and actors that can participate in the workflow. By way of illustration, workflows can be used to model an organization's content approval process. In various embodiments, workflows can be nested within workflows. This allows for complex workflows to be compartmentalized for easy manipulation and development. Various embodiments include a workflow definition, an extensible workflow system, an interactive workflow design tool to generate and/or modify workflow definitions, and means for workflows to interact with other systems. If a content repository does not natively support workflows, the VCR can provide support.

In various embodiments, a workflow can be associated with, or be a property of, a node. In aspects of these embodiments, if a workflow is associated with a hierarchy node, the children of the hierarchy node will also be associated with the workflow. Likewise, if a workflow is associated with a schema, nodes instantiated based on the schema will also be associated with the workflow. Workflows can also be directly associated with content nodes.

In various embodiments and by way of illustration, a node can transition from a current state to a new state. Before, during or after a transition, one or more actions can be performed. Actions can optionally operate on and/or utilize the node. Actions can include any type of processing that can be invoked in the course of the workflow. By way of an example, actions can include function/method calls, remote procedure calls, inter-process communication, intra-process communication, interfacing with hardware devices, checking a node into/out of version control, assigning the node to a user, group or role, performing some kind of processing on the node (depending on any policies that may be defined on the node), providing a notification to users, groups and/or roles, and other suitable processing. Actions can also be specified as command(s), directive(s), expression(s) or other constructs that can be interpreted or mapped to identify required processing. For example, high-level action directives such as “publish” could cause a content node to be published, and an e-mail or other message to be sent to certain parties. It will be apparent to those of skill in the art that any action is within the scope and the spirit of the present disclosure.

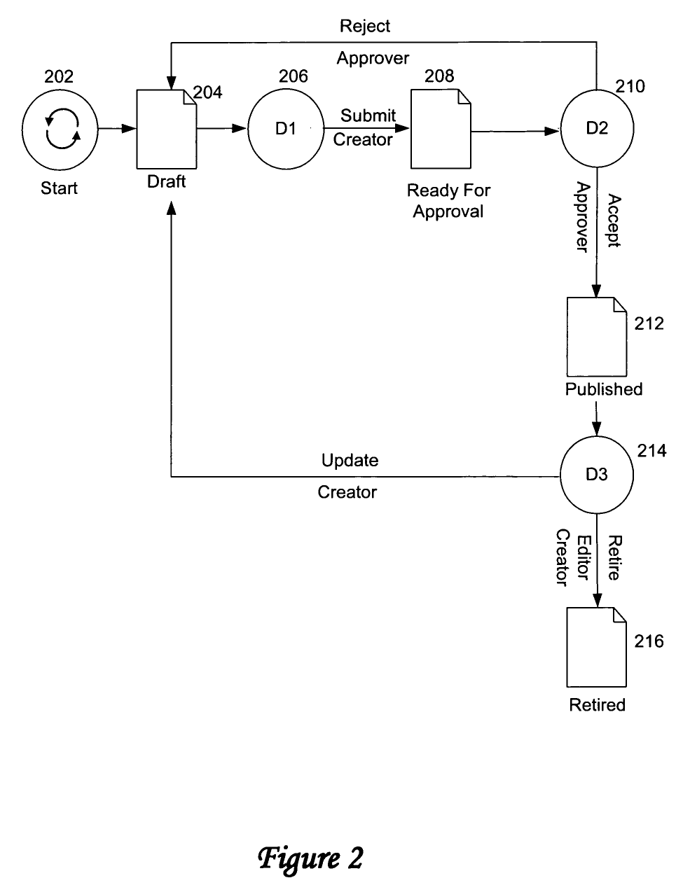

An example workflow for a content node representing a news article is illustrated in Table 6 and FIG. 2. States are illustrated in FIG. 2 as document icons (204, 208, 212, 216) and decision points between states are illustrated as circles (206, 210, 214). Transitions between states are illustrated as lines that are directed to show the order of states. In aspects of certain of these embodiments, transitions between states can pass through one or more decision points. A decision point is a visual placeholder (e.g., an icon in an IDE graphical editor) for restricting transitions to user(s), groups(s), and role(s); and for specifying action(s) that can accompany a change in state, if any. A decision point can connect a state to at least one other state. Actions can be controlled by policies and/or roles associated with the node and keyed off of the workflow state (e.g., state can be a property of a node) to allow certain classes of users/processes privileges in different states.

TABLE 6
Example Workflow in Various Embodiments

| CURRENT STATE | ACTION(S) | ROLE(S) | NEXT STATE |
|---|---|---|---|
| Start | | | Draft |
| Draft | Submit | Creator | Ready for Approval |
| Ready for Approval | Accept | Approver | Published |
| Ready for Approval | Reject | Approver | Draft |
| Published | Retire | Editor, | Retired |
| | | Creator | |
| Published | Update | Creator | Draft |

The example workflow in FIG. 2 begins at Start state 202 which has an unrestricted transition to the next state in the workflow, the Draft state 204. A transition can be unrestricted or restricted to a set of user(s), group(s) and/or role(s). In aspects of these embodiments, a role can be delegated to a user through delegated administration. By way of illustration, approval capabilities can be based on capabilities in a delegated administration model. In one embodiment, a restriction can provide that only certain authorized users/processes can bring about a transition to the next state. In various embodiments, a state change can be initiated by a user interacting with the node through a tool and/or by a process interacting with the node through the VCR API. In certain aspects of these embodiments, the current state of a node is a property of the node. By way of an example, modifying the state property (e.g., changing it from “Start” to “Draft”, assuming the user/process is authorized to do so), can cause attendant workflow processing to take place, such as performing actions defined on the transition.

The news article can be modified by user(s) and/or process(es) while in the Draft state and then submitted for approval. By way of an example, a user can check-out the news article (assuming it is under version control), modify it, and then check-in the article with the changes. Before checking the article in, the user can change the state property from “Draft” to “Ready for Approval” in order to bring about a transition to the Ready for Approval 208 state. By way of a further illustration, a user interface can present a button or a menu option that a creator can be selected when the user has finished editing the article. Once selected, the article can be automatically submitted to the workflow where it can progress to the next state. In this illustration, the transition through decision point D1 206 to the Ready for Approval state is constrained to users in the Creator role. Thus, only a user/process that created the article can cause the article to transition into the Ready for Approval state.

The transition from Draft to Ready for Approval also has an accompanying action, Submit. By way of an example, this action can cause a notification to be sent to those interested in reviewing articles for approval. Alternatively, or in addition to this, the news article can be assigned to users/groups/roles. In this way, users/processes that are in the assigned users/groups/roles can review it while it is in the Ready for Approval state. From the Ready for Approval state, there is a transition through decision point D2 210. The D2 decision point specifies that a user/process in the Approver role can cause a transition to the Draft state 204 or to the Published state 212. If the transition is to the Draft state, the action associated with the transition will be to Reject the article. A rejected article will repeat the workflow path from Draft to Ready for Approval. If the transition is to the Published state, however, the action will be to Accept the article. Once the article is in the Published state, a user/process in the role of Editor or of Creator can cause a transition to the Retired state 216. A user in the role of Creator can cause a transition to the Draft state. Transitioning from the Published state to the Draft state causes an Update action whereas transitioning from the Published state to the Retired state causes a Retire action.

In aspects of these embodiments, roles can be organized into a role hierarchy such that superior roles can skip state transitions required of inferior roles. By way of illustration, suppose the Approver role was superior to the Creator role. If the current workflow state of the article was Draft, a user in the role of Approver could skip the Ready for Approval state and transition the article all the way to the Published state. In one embodiment, actions associated with the decision points D1 and D2 could be automatically invoked even though the Ready for Approval state was skipped.

In various embodiments and by way of illustration, workflows can be defined using a text editor and/or an IDE. From a text editor a user can create a full workflow definition in a language (e.g., XML). In a graphical environment, a user can create different states and then connect them together to represent transitions. In an embodiment, a graphical depiction of a workflow can appear as in FIG. 2. Graphical representations of states and decision nodes can be placed onto an IDE canvas and connected to form transitions. Property sheets associated with the graphical objects can allow a user to interactively specify roles and actions associated with states and/or transitions. In aspects of these embodiments, a user can easily switch between graphical and textual representations of a workflow since both representations are equivalent.

In various embodiments, third party workflow engines can be invoked. This allows additional functionality to be seamlessly incorporated into the workflow model. In one embodiment, this can be accomplished from within a workflow through workflow actions. In another embodiment, third party workflows can be invoked through a callback mechanism. By way of illustration, the VCR API can invoke a third party workflow in response to certain events, such as when a content node/scenario has been modified and/or its state property has changed. In this illustration, a process that implements a third party workflow can register to receive callbacks when these events occur. The callback notification can also include the VCR node identifier and optionally context information such as information about the user/process that caused the event.

In various embodiments, workflows can be utilized from other processes. The VCR API includes a workflow interface to allow access to a node's workflow definition. In addition, the workflow interface allows a process to drive a node through the workflow by providing functionality such as the ability to ascertain a node's current state, place the node in a new state based on transition choices available from its current state, and invoke actions associated with a state transition.

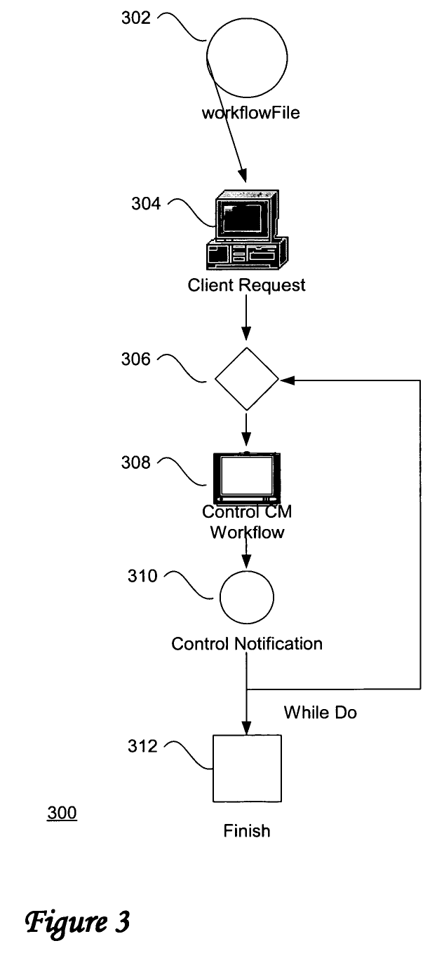

FIG. 3 is an illustration of an example external scenario that invokes a workflow in various embodiments. From an IDE, a user can create a visual representation of a scenario as depicted in FIG. 3. In this illustration, the scenario includes a starting point 302 icon followed by a client request control icon 304 that represents a process for receipt of a client request. After the request is received, the scenario enters a “while” loop 306. Within the loop, a workflow control icon 308 representing a VCR workflow causes the associated workflow to be invoked. The workflow control can have associated properties that identify the workflow and the node that it will drive through the workflow. In aspects of these embodiments, a control can be a Java™ control. The workflow control can drive the node through the workflow using the workflow interface of the VCR API. After the workflow has completed, the scenario invokes a notification control 310 that can cause a notification of workflow completion to be sent to various user/process.

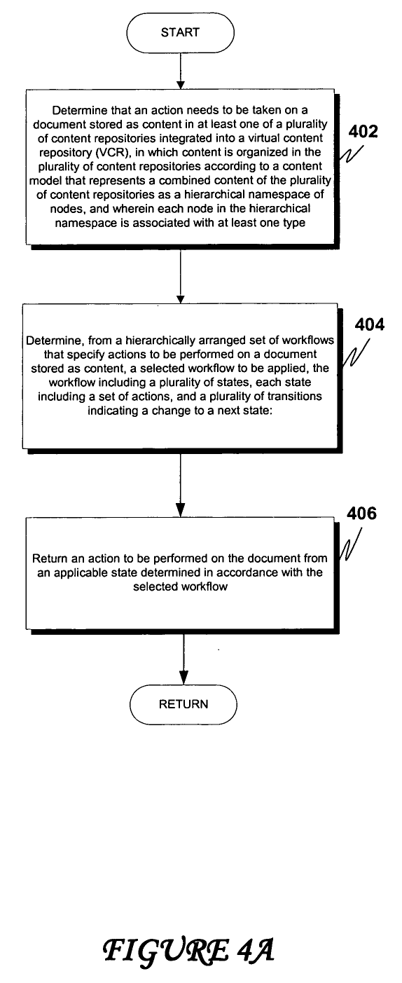

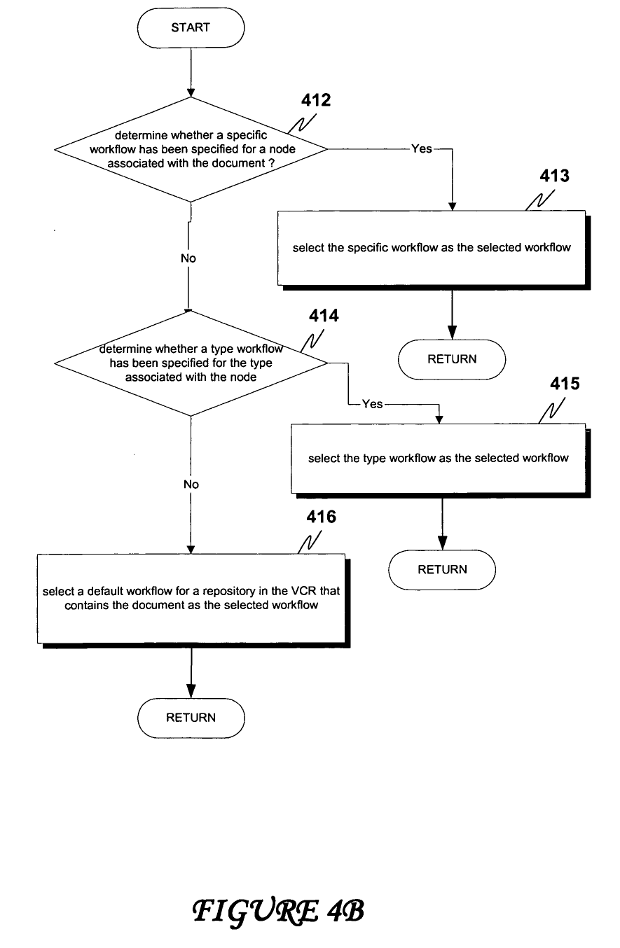

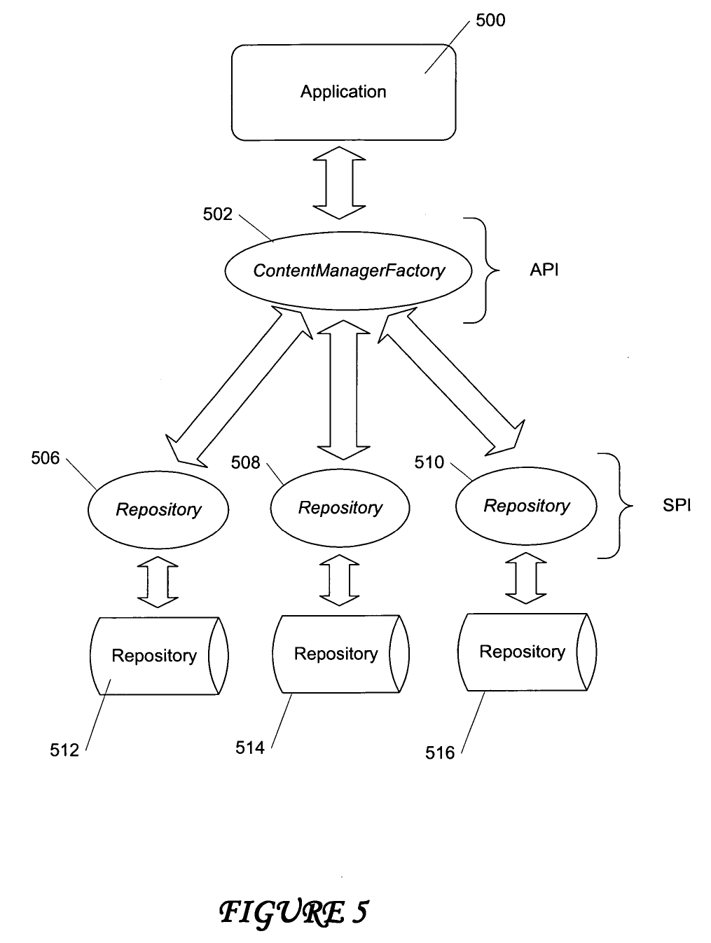

FIG. 4A is an operational flow diagram illustrating a high level overview of a technique for managing content by workflows in an embodiment. The technique for managing content by workflows shown in FIG. 4A is operable with an application, such as application 500 of FIG. 5 for example. As shown in FIG. 4A, a determination is made that an action needs to be taken on a document stored as content in at least one of a plurality of content repositories integrated into a virtual content repository (VCR) (block 402). For example and without limitation, this can include receiving a request to take an action on the document. Requests can be made by a requester, which may be a human user or a computational entity.

A selected workflow to be applied is determined from a hierarchically arranged set of workflows that specify actions to be performed on a document stored as content (block 404). The workflow includes a plurality of states, each state including a set of actions, and a plurality of transitions indicating a change to a next state. By way of example and without limitation, this can include performing processing described below with reference to FIG. 4B. An action to be performed on the document is returned (block 406). The action is determined from an applicable state in accordance with the selected workflow. In embodiments, this can include returning a next state in the selected workflow also.

Some embodiments can enable a user to define the workflow by receiving information about at least one of a state, a transition from a first state to a second state, and an action to be associated with a state, and incorporating the information into at least one workflow associated with the VCR.

FIG. 4B is an operational flow diagram illustrating a high level overview of a technique for managing content by workflows in an embodiment. As shown in FIG. 4B, it is determined whether a specific workflow has been specified for a node associated with the document (block 412). The specific workflow is selected as the selected workflow if the specific workflow exists (block 413). Otherwise, it is determined whether a type workflow has been specified for the type associated with the node (block 414). If so, then the type workflow is selected as the selected workflow (block 415). Otherwise, a default workflow for a repository in the VCR that contains the document is selected as the selected workflow (block 416).

FIG. 5B is an example illustration of objects/interfaces that can be used to interface repositories comprising content in various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

The ContentManagerFactory 502 can serve as a representation of an access device from an application program's 500 point of view. In aspects of these embodiments, the ContentManagerFactory attempts to connect all available repositories to the device (e.g., 512-516); optionally with user or process credentials. In various embodiments, this can be based on the Java™ Authentication and Authorization Service (available from Sun Microsystems, Inc.). Those of skill in the art will recognize that many authorization schemes are possible without departing from the scope and spirit of the present disclosure. An SPI Repository object 506-510 represents each available content repository. In an embodiment, the ContentManagerFactory can invoke a connect( ) method on the set of Repository objects. It is noteworthy that, in some embodiments, the notion of “connecting” to a repository is not exposed to users. In various embodiments, the ContentManagerFactory returns a list of repository session objects to the application program, one for each repository for which a connection was attempted. Any error in the connection procedure can be described by the session object's state. In another embodiment, the ContentManagerFactory can connect to a specific repository given the repository name. In various embodiments, the name of a repository can be a URI (uniform resource identifier).

Workflow Functionality

Embodiments can enable the following functionality:
Workflow Managment is scoped at the SPI level. Each repository can have it's own list of workflow documents.
Workflows can be associated with Nodes (Content or Hierarchy) or Types.
The name of the workflow document is unique within a repository.
Each repository will have a default workflow that cannot be removed by the user, but the user can replace the existing default workflow with a new default workflow.
The first version will always have the status set in the beginstatus element in the workflow document. For the Default workflow, it is set to workflow.DRAFT.
When checking out a node whose last version is workflow.PUBLISHED, it will revert to that version with the same status as defined in the beginstatus element.
When a workflow has been changed on a node after it has gone through a few version iterations, the workflow management API will allow users to checkout and checkIn workflow statuses that might not exist in the workflow document. Since there will be no actions for these kind of statuses, the checkln operation will unlock the node, but leave the workflow status to the original state.
   Node Based Workflows

In embodiments, when a workflow document has been associated with a Node, it exhibits the following characteristics:
The workflow document follows inheritance down to child nodes. For example, consider an inheritance hierarchy of: NodeA->NodeB->NodeC [where->indicates parent of ]. If the workflow is set to “HR” on NodeA, then NodeB and NodeC will all use the same workflow.
Once a workflow document is in use by a node, it cannot be modified until it is disassociated from the node. However, the meta-data of the lifeycle (name, comment) can still be modified.
   Type Based Workflows

In an embodiment, when a user associates a workflow document with a type, it exhibits the following characteristics:
Type based workflows are inherited down to subtypes, but they do not affect nested types in a given type.
The order of precedence in terms of which workflow document is enforced is as follows:
   Workflow on an individual node/content item.
   Workflow of a Type
   Inherited workflow from a node.
   Default workflow if none is specified.
      Workflow Document Schema

In an embodiment, workflows may be specified with a workflow document that will be an xml representation of workflow status and transitions. This can enable embodiments to provide advantages of portability and broad acceptance. An example workflow schema is illustrated below:

```
- <xs:schema targetNamespace=“http://schema.lifecycle.virtual.content.bea.com” xmlns:xs=“http://www.w3.
    xmlns=“http://schema.lifecycle.virtual.content.bea.com” elementFormDefault=“qualified” attributeFormDefa [symbol]
  - <xs:element name=“life-cycle”>
    - <xs:annotation>
        <xs:documentation>The content life cycle</xs:documentation>
      </xs:annotation>
    - <xs:complexType>
      - <xs:sequence>
        - <xs:element name=“transition” maxOccurs=“unbounded”>
          - <xs:complexType>
            - <xs:sequence>
              - <xs:element name=“from-status”>
                - <xs:complexType>
                  - <xs:sequence>
                      <xs:element name=“capabilityConstraint” type=“xs:string” maxOccurs=“unbounded” />
                      <xs:element name=“roleConstraint” type=“xs:string” maxOccurs=“unbounded” />
                    </xs:sequence>
                    <xs:attribute name=“id” type=“xs:integer” use=“required” />
                  </xs:complexType>
                </xs:element>
              - <xs:element name=“to-status” maxOccurs=“unbounded”>
                - <xs:complexType>
                  - <xs:sequence>
                    - <xs:element name=“action” maxOccurs=“unbounded”>
                      - <xs:complexType>
                          <xs:attribute name=“class” type=“xs:string” use=“required” />
                        </xs:complexType>
                      </xs:element>
                      <xs:element name=“capabilityConstraint” type=“xs:string” maxOccurs=“unbounded” />
                      <xs:element name=“roleConstraint” type=“xs:string” maxOccurs=“unbounded” />
                    </xs:sequence>
                    <xs:attribute name=“id” type=“xs:integer” use=“required” />
                  </xs:complexType>
                </xs:element>
              </xs:sequence>
            </xs:complexType>
          </xs:element>
        - <xs:element name=“status” maxOccurs=“unbounded”>
          - <xs:complexType>
              <xs:attribute name=“id” type=“xs:integer” use=“required” />
              <xs:attribute name=“text” type=“xs:string” use=“required” />
            </xs:complexType>
          </xs:element>
        - <xs:element name=“beginStatus” maxOccurs=“1”>
          - <xs:complexType>
              <xs:attribute name=“id” type=“xs:integer” use=“required”/>
            </xs:complexType>
          </xs:element>
        </xs:sequence>

[symbol]

```

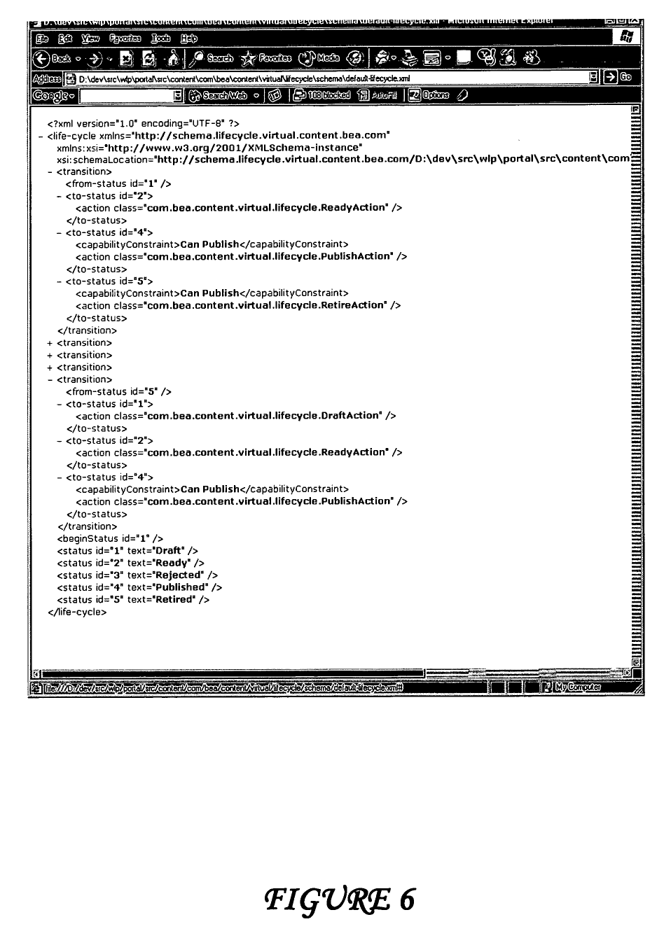

FIG. 6 illustrates a sample document that uses the above schema in an embodiment. In the illustrated workflow document, the following are true:
Status 1 to 5 are reserved by the system and should not be over-ridden by the end-user
Users can however change the display text of these status if they want to
Since the schema does not validate the fact that the status id present in the <from-status> element or the <to-status> element have a corresponding <status> text definition element, it will be up to the user to ensure that consistency.
The roleConstraint element specifies that a user should be in a one of both DA and visitor entitlement roles to execute this transition. These roles are hard-coded in the xml, so if they are modified from the Idap store, it is the responsibility of the author of the workflow document to synchronize them with the Idap store.

In an embodiment, workflow actions are governed by the following behavioral rules:
1. If multiple actions are defined for a particular transition, the execute ( ) method will be called on each of these actions in the order they are specified in the workflow document.
2. If any of these methods throw an exception, the system will call the revertAction ( ) method on each action in the reverse order of what is specified in the workflow document.
3. The action reference mechanism is synchronous. So it is the responsibility of the action implementer to return as quickly as possible when the action is completed.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the machine readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for managing content by workflows as discussed herein.

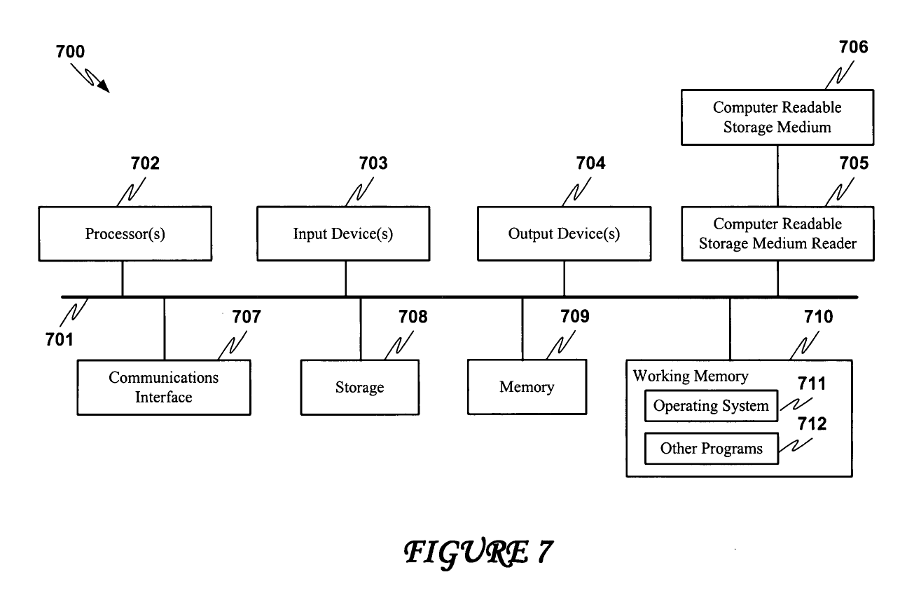

FIG. 7 illustrates a processing system 700, which can comprise one or more of the elements of FIG. 1. Turning now to FIG. 7, a computing system is illustrated that may comprise one or more of the components of FIG. 1. While other alternatives might be utilized, it will be presumed for clarity sake that components of the systems of FIG. 1 are implemented in hardware, software or some combination by one or more computing systems consistent therewith, unless otherwise indicated.

Computing system 700 comprises components coupled via one or more communication channels (e.g., bus 701) including one or more general or special purpose processors 702, such as a Pentium®, Centrino®, Power PC®, digital signal processor (“DSP”), and so on. System 700 components also include one or more input devices 703 (such as a mouse, keyboard, microphone, pen, and so on), and one or more output devices 704, such as a suitable display, speakers, actuators, and so on, in accordance with a particular application. (It will be appreciated that input or output devices can also similarly include more specialized devices or hardware/software device enhancements suitable for use by the mentally or physically challenged.)

System 700 also includes a machine readable storage media reader 705 coupled to a machine readable storage medium 706, such as a storage/memory device or hard or removable storage/memory media; such devices or media are further indicated separately as storage 708 and memory 709, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 707 may also be included, such as a modem, DSL, infrared, RF or other suitable transceiver, and so on for providing inter-device communication directly or via one or more suitable private or public networks or other components that may include but are not limited to those already discussed.

Working memory 710 further includes operating system (“OS”) 711 elements and other programs 712, such as one or more of application programs, mobile code, data, and so on for implementing system 700 components that might be stored or loaded therein during use. The particular OS or OSs may vary in accordance with a particular device, features or other aspects in accordance with a particular application (e.g. Windows®, WindowsCE™, Mac™, Linux, Unix or Palm™ OS variants, a cell phone OS, a proprietary OS, Symbian™, and so on). Various programming languages or other tools can also be utilized, such as those compatible with C variants (e.g., C++, C#), the Java™2 Platform, Enterprise Edition (“J2EE”) or other programming languages in accordance with the requirements of a particular application. Other programs 712 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 708 or memory 709) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for managing content by workflows in a content management system, the method comprising:
determining that an action needs to be taken on a document stored as content in at least one of a plurality of content repositories integrated into a virtual content repository (VCR), in which content is organized in the plurality of content repositories according to a content model that represents a combined content of the plurality of content repositories as a hierarchical namespace of nodes, and wherein each node in the hierarchical namespace is associated with at least one type;
determining, from a hierarchically arranged set of workflows that specify actions to be performed on a document stored as content, a selected workflow to be applied, the workflow including a plurality of states, each state including a set of actions, and a plurality of transitions indicating a change to a next state; and
returning an action to be performed on the document from an applicable state determined in accordance with the selected workflow.

2. The method of claim 1, wherein determining that an action needs to be taken on a document stored as content in at least one of a plurality of content repositories integrated into a virtual content repository (VCR) includes:
receiving, from a requester, a request to take an action on the document stored as content in at least one of a plurality of content repositories integrated into a virtual content repository (VCR).

3. The method of claim 1, wherein determining, from a hierarchically arranged set of workflows that specify actions to be performed on a document stored as content, a selected workflow to be applied, the workflow including a plurality of states, each state including a set of actions, and a plurality of transitions indicating a change to a next state includes:
determining whether a specific workflow has been specified for a node associated with the document and selecting the specific workflow as the selected workflow when the specific workflow exists; otherwise,
determining whether a type workflow has been specified for the type associated with the node and selecting the type workflow as the selected workflow when the type workflow exists; otherwise,
selecting a default workflow for a repository in the VCR that contains the document as the selected workflow.

4. The method of claim 1, wherein returning an action to be performed on the document from an applicable state determined in accordance with the selected workflow includes:
returning a next state in the selected workflow.

5. The method of claim 1, further comprising:
receiving information about at least one of a state, a transition from a first state to a second state, and an action to be associated with a state; and
incorporating the information into at least one workflow associated with the VCR.

6. A machine-readable medium carrying one or more sequences of instructions for managing content by workflows in a content management system, which instructions, when executed by one or more processors, cause the one or more processors to carry out the steps of:
determining that an action needs to be taken on a document stored as content in at least one of a plurality of content repositories integrated into a virtual content repository (VCR), in which content is organized in the plurality of content repositories according to a content model that represents a combined content of the plurality of content repositories as a hierarchical namespace of nodes, and wherein each node in the hierarchical namespace is associated with at least one type;
determining, from a hierarchically arranged set of workflows that specify actions to be performed on a document stored as content, a selected workflow to be applied, the workflow including a plurality of states, each state including a set of actions, and a plurality of transitions indicating a change to a next state; and
returning an action to be performed on the document from an applicable state determined in accordance with the selected workflow.

7. The machine-readable medium as recited in claim 6, wherein the instructions for carrying out the step of determining that an action needs to be taken on a document stored as content in at least one of a plurality of content repositories integrated into a virtual content repository (VCR) include instructions for carrying out the step of:
receiving, from a requester, a request to take an action on the document stored as content in at least one of a plurality of content repositories integrated into a virtual content repository (VCR).

8. The machine-readable medium as recited in claim 6, wherein the instructions for carrying out the step of determining, from a hierarchically arranged set of workflows that specify actions to be performed on a document stored as content, a selected workflow to be applied, the workflow including a plurality of states, each state including a set of actions, and a plurality of transitions indicating a change to a next state include instructions for carrying out the step of:
determining whether a specific workflow has been specified for a node associated with the document and selecting the specific workflow as the selected workflow when the specific workflow exists; otherwise,
determining whether a type workflow has been specified for the type associated with the node and selecting the type workflow as the selected workflow when the type workflow exists; otherwise,
selecting a default workflow for a repository in the VCR that contains the document as the selected workflow.

9. The machine-readable medium as recited in claim 6, wherein the instructions for carrying out the step of returning an action to be performed on the document from an applicable state determined in accordance with the selected workflow include instructions for carrying out the step of:
returning a next state in the selected workflow.

10. The machine-readable medium as recited in claim 6, further comprising instructions for carrying out the steps of:
receiving information about at least one of a state, a transition from a first state to a second state, and an action to be associated with a state; and
incorporating the information into at least one workflow associated with the VCR.

11. An apparatus for managing content by workflows in a content management system, the apparatus comprising:
a processor; and
one or more stored sequences of instructions which, when executed by the processor, cause the processor to carry out the steps of:
determining that an action needs to be taken on a document stored as content in at least one of a plurality of content repositories integrated into a virtual content repository (VCR), in which content is organized in the plurality of content repositories according to a content model that represents a combined content of the plurality of content repositories as a hierarchical namespace of nodes, and wherein each node in the hierarchical namespace is associated with at least one type;
determining, from a hierarchically arranged set of workflows that specify actions to be performed on a document stored as content, a selected workflow to be applied, the workflow including a plurality of states, each state including a set of actions, and a plurality of transitions indicating a change to a next state; and
returning an action to be performed on the document from an applicable state determined in accordance with the selected workflow.

12. A method for transmitting code on a transmission medium, comprising:
transmitting code to determine that an action needs to be taken on a document stored as content in at least one of a plurality of content repositories integrated into a virtual content repository (VCR), in which content is organized in the plurality of content repositories according to a content model that represents a combined content of the plurality of content repositories as a hierarchical namespace of nodes, and wherein each node in the hierarchical namespace is associated with at least one type;
transmitting code to determine, from a hierarchically arranged set of workflows that specify actions to be performed on a document stored as content, a selected workflow to be applied, the workflow including a plurality of states, each state including a set of actions, and a plurality of transitions indicating a change to a next state; and
transmitting code to return an action to be performed on the document from an applicable state determined in accordance with the selected workflow.
